(19) United States
(12) Patent Application Publication
(10) Pub. No.: US 2026/0309495 A1
(43) Pub. Date: Oct. 8, 2026

(54) QUANTUM-ENHANCED GYROSCOPES

(71) Applicant: ARIZONA BOARD OF REGENTS ON BEHALF OF THE UNIVERSITY OF ARIZONA, Tucson, AZ (US)

(72) Inventor: Zheshen ZHANG, Tucson, AZ (US)

(21) Appl. No.: 18/996,752

(22) PCT Filed: Aug. 17, 2023
(86) PCT No.: PCT/US2023/030518

§ 371 Date: Jan. 17, 2025

Related U.S. Application Data
(60) Provisional application No. 63/398,761, filed on Aug. 17, 2022.

(51) Int. Cl. G01C 19/72

(52) U.S. Cl. CPC G01C 19/721; G01C 19/727

(57) ABSTRACT

Quantum squeezed or entangled light is used to enhance the sensitivity of gyroscopes. A quantum-enhanced gyroscopic device includes a mirror resonator and a light source that provides light to probe the mirror resonator. The light includes quantum-enhanced light, such as counter-propagating quantum squeezed light or quantum entangled light. The mirror resonator may include an optical ring cavity or an optical linear cavity. The use of the quantum light enhances the Pound-Drever-Hall (PDH) lock sensitivity and suppresses the extra noise induced by Kerr nonlinearities.

### CROSS-REFERENCE TO RELATED APPLICATIONS

This application claims priority to U.S. Provisional Patent Application No. 63/398,761, filed on Aug. 17, 2022, the contents of which are hereby incorporated by reference.

### GOVERNMENT SPONSORSHIP

This invention was made with U.S. government support under Grant Nos. 2040575 and 2134830 awarded by the National Science Foundation (NSF). The government has certain rights in the invention.

### BACKGROUND

According to relativity theory, time and frequency are a pair of conjugate properties of local time space and relative speed between two frames. Current technology of ultra-precision calibration of the local time space relies on laser frequency stability. Laser frequency stability supports atomic clocks for standard timing and the Laser Interferometer Gravitational-Wave Observatory (LIGO) for state-of-the-art gravitational-wave detection.

The former is the key apparatus for the next-generation global positioning systems, and the latter provides new perspectives of the universe. Based on special relativity, the relative linear motion between the observer and the object causes a tiny frequency shift, and the rotation causes a slight phase shift, a.k.a. the Doppler effect and Sagnac effect. These small changes can be precisely estimated and tracked if their frequencies are locked to a common reference. Pound-Drever-Hall (PDH) locking is a common technique for frequency locking. PDH locking may be used in applications of optical gyroscopes. Moreover, stable frequency locking is indispensable in the new tide of quantum technology, where modern laser and microwave systems are operating artificial or natural quantum objects coherently to maintain potential quantum advantages.

Fundamentally, the lasing process is sensitive to the environment. To mitigate turbulence, one needs to lock the laser frequency to a more stable resonating reference led by a natural periodicity. An optical cavity is widely utilized to form such an artificial resonance. Optical cavities are versatile in multiple aspects, such as tunable wavelengths and high stability. The PDH locking technique, whose stability is independent of laser intensity noise, has become the mainstay of laser frequency locking. PDH techniques may either lock the laser to a finer external cavity, or vice versa-lock the resonance of a cavity to a more stable laser. However, the ultimate performance of PDH locking techniques are bound by the shot-noise limit of the phase quadrature due to the quantum nature of the laser field.

Thus, it is desirable to provide a quantum-enhanced device that is able to overcome some of the current disadvantages, such as the shot-noise limit. Other advantages of embodiments disclosed herein will become more apparent from the detailed description below.

### SUMMARY

Our recent progress in manipulating light fields reveals that squeezed light can be used to surpass the shot-noise limit in some applications, when directed by the framework of quantum optics. Embodiments disclosed herein include a scheme dubbed “squeezed-light-enhanced PDH locking.” In embodiments, the squeezed-light helps to suppresses the noise floor in PDH locking techniques. Embodiments disclosed herein may provide the capability to further enhance frequency locking stability by utilizing the quantum characteristics of the squeezed light.

In one aspect, embodiments disclosed herein are directed to a quantum-enhanced gyroscopic device that includes a mirror resonator and a light source that provides light to probe the mirror resonator. The light includes quantum-enhanced light, such as counter-propagating quantum squeezed light or quantum entangled light. The mirror resonator may include an optical ring cavity or an optical linear cavity.

The device may include a beam splitter that splits the light into a first split portion and a second split portion. The mirror resonator is part of a PDH device that locks the first split portion to a resonant frequency. The frequency shift between the first split portion and the second split portion is used to control the light source.

In another aspect, embodiments are directed to a squeezed-light enhanced PDH locking module that includes a light source that provides quantum-enhanced light and a beam splitter that splits the quantum-enhanced light into a first split portion and a second split portion. The module also includes a mirror resonator that locks the first split portion to a resonant frequency. The frequency shift between the first split portion and the second split portion is used to lock the module.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of a device according to some embodiments.

FIG. 2A demonstrates the power of de-modulated noise with respect to detuning in accordance with one or more embodiments. FIG. 2B demonstrates a sensitivity at the critical coupling point at zero detuning in accordance with one or more embodiments.

FIG. 3A demonstrates sensitivities depending on the coupling regime when the power of each sideband is 1% of the total power in accordance with some embodiments. FIG. 3B demonstrates sensitivities at the critical coupling point with biased detuning at 1% power.

FIG. 3C demonstrates sensitivities depending on coupling regime when the power of each sideband is 10% of the total power. FIG. 3D demonstrates sensitivities at the critical coupling point with biased detuning at 10% power.

FIG. 4 is a microscope image of an on-chip squeezed light source, according to some embodiments.

### DETAILED DESCRIPTION

It is to be understood that the figures and descriptions of the present invention may have been simplified to illustrate elements that are relevant for a clear understanding of the present invention, while eliminating, for purposes of clarity, other elements found in a typical gyroscope, an inertial measurement unit (IMU), typical methods associated with gyroscopes, or typical methods associated with an IMU. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

In general, embodiments disclosed herein use quantum-squeezed or entangled light to enhance the sensitivity of gyroscopic devices. In embodiments, quantum light is used to enhance locking sensitivity in a PDH type device. The quantum light also suppresses noise induced by Kerr nonlinearity effects. This enables an overall gain in performances of gyroscopic devices.

Embodiments utilize a mirror resonator that is probed with quantum-enhance light. The quantum enhanced light may be counter-propagating quantum squeezed light or entangled light. An upper arm of the PDH type device is used to lock the laser to the resonant frequency, while a lower arm measures the frequency shift in an open loop configuration.

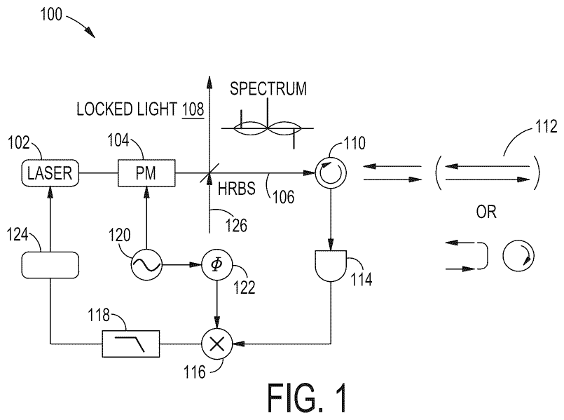

FIG. 1 demonstrates a schematic diagram of a general module (100) for quantum-enhanced PDH locking. The module includes a laser (102) output to a phase modulator (104) and then incident on a beam splitter (106). The beam splitter (106) may be a high reflectivity beam splitter (HRBS). The beam splitter (106) splits the locked light (108) away from the module (100). The beam splitter (106) further splits a small portion of the light to a circulator (110) that is connected to an optical cavity (112) and photodetector (114). In embodiments herein, the optical cavity (112) may be a linear cavity or a ring cavity.

The photodetector (114) is connected to a demodulation circuit with feedback control. More specifically, the photodetector (114) is connected to a mixer (116) and a low pass filter (118) that serves as a demodulator around the modulation frequency supplied by the RF signal (120) and phase shifter (122). A Proportional-Integral-Derivative (PID) controller (124) is used to feedback a frequency-dependent gain to focus on either compensating the slow drifting or tracking the fast fluctuation of the system.

In accordance with embodiments disclosed herein, the module (100) includes an external broadband squeezing source (126) that is combined with the light field at the beam splitter (106), after the phase modulator (104). For example, a squeezed vacuum functions as the squeezing source (126). In other embodiments, a bright squeezed light source may be used in place of the squeezing source (126). The module (100) directly modulates on the squeezed light source to create the appropriate sidebands.

During locked lasing, the beamsplitter (106) reflects most of the power for particular applications in the locked light (108), but leaves a small portion of light for the locking. The sinuous-microwave-driven phase modulator (104) transfers a part of energy from the carrier frequency, and equally splits to a higher frequency component and a lower frequency component. This symmetrically generates two sidebands at each side of the carrier field with opposite relative phases on the spectrum. The absolute frequency detune is the same as the modulation frequency.

In embodiments, the modulated light field is filtered by the transfer function of the optical cavity (112). That is, the optical cavity (112) reflects most of the energy from the two sidebands to the photodetector (114) and absorbs most power of the carrier.

In some high reflectivity embodiments, the sidebands may be completely reflected at the cavity (112). However, in other embodiments, the sidebands may pass into and out of the cavity (112) before being detected by the photodetector (114).

At the photodetector (114), the remaining carrier field and the two sidebands form a beat signal that is demodulated around the modulation frequency (via the RF signal (120)) by the mixer (116) and a low-pass filter (118). At this time, the signal amplitude is proportional to the relative detuning between the laser frequency and the central frequency of the cavity resonance.

Accordingly, the signal and noise can be fed back to the laser driver using the PID controller (124) to minimize the relative frequency difference. The PID controller (124) may assign a frequency-dependent gain to focus on either compensating for slow drifting or tracking fast fluctuations of the system. The noise floor is fundamentally determined by the shot noise carried in the carrier mode and sideband modes, which can affect locking performance when the signal-to-noise ratio (SNR) is low.

As previously noted, in some embodiments, an external broadband squeezed light source may be used. The external broadband squeezed light source replaces the input vacuum noise by a squeezed noise profile. At the carrier frequency, the noise floor is reduced to the level of the single-mode squeezed state. In accordance with embodiments, the covariant two-mode squeezed vacuum further decreases the correlated noise between the two symmetrical sidebands. Consequently, the squeezed-light enhanced PDH locking techniques disclosed herein enjoy a sub-shot-noise floor without compromising the benefits of extracting an intensity-insensitive signal necessary in traditional PDH locking techniques.

The following describes the improvements led by a two-mode squeezed vacuum at the sidebands. Accordingly, the field at the central frequency contains the seed light, similar to current experimental designs for generating squeezed light.

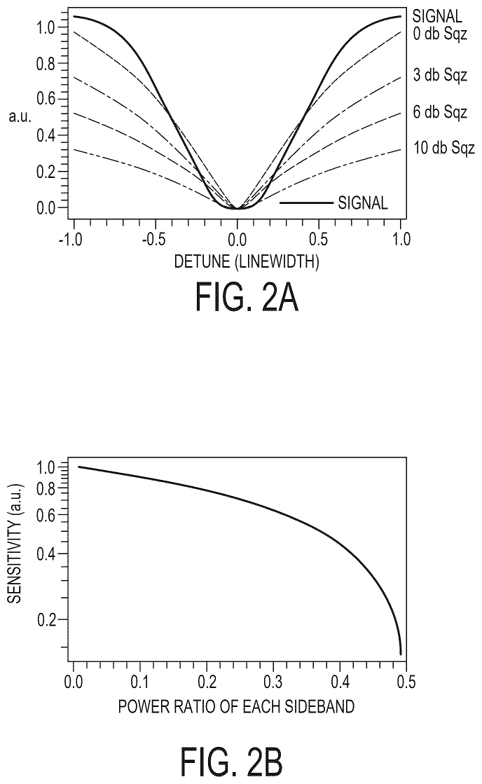

FIG. 2 demonstrates the performance of squeezed-light enhanced PDH locking with a critical-coupled cavity. In FIG. 2, all of the y-axes are normalized to the unity for each figure.

FIG. 2A demonstrates the power of the de-modulated noise (dashed lines) and the signal (solid line) with respect to different applied detunings. In FIG. 2A, the power of each sideband is 1% of the total power. The zero dB squeeze (0 dB Sqz) is substantially identical to that seen in conventional PDH locking techniques. FIG. 2B demonstrates the best sensitivity at the critical coupling point at zero detuning, when the power ratio of each sideband is different.

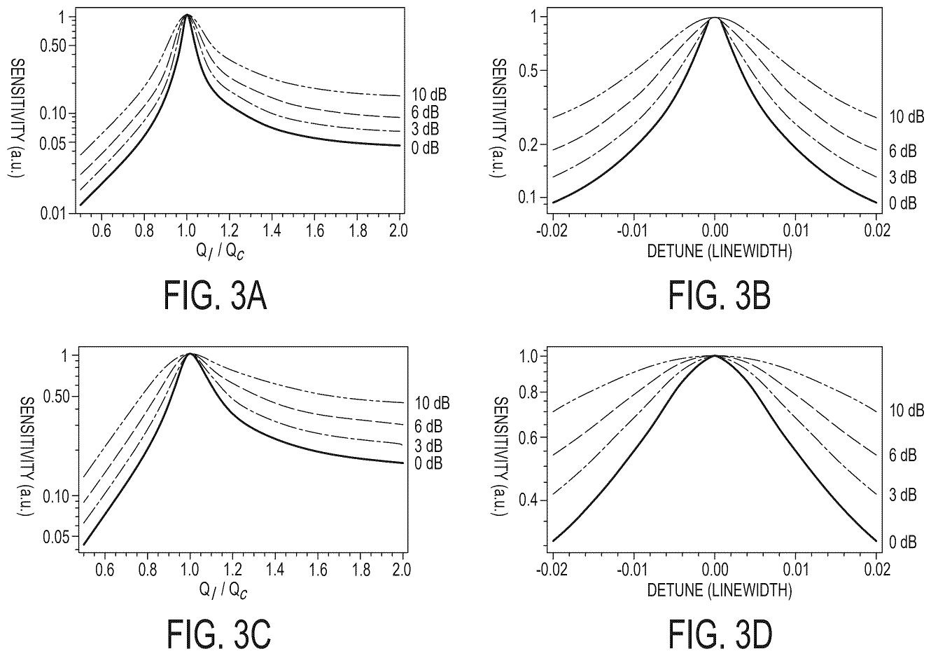

As can be seen, the signal is proportional to the frequency detune, and the most significant slope locates at the critical coupling point. When the detune is small, the signal power is higher, but at the same time, the noise is growing faster. As a result, the SNR is decreasing. The sensitivity is also decreasing as will be shown below in FIG. 3B.

With a higher squeezing level in the squeezed-light-enhanced PDH locking scheme, the noise at non-zero detuning will be squeezed harder, which leads to better sensitivity and SNR. However, if more power is modulated into the sidebands, the overall sensitivity may be impaired, as demonstrated in FIG. 2B.

FIG. 3 demonstrates sensitivities of squeezed-light enhanced PDH locking at given squeezing levels in accordance with embodiments disclosed herein. FIG. 3A shows sensitivity curves based on the coupling regime when the power of each sideband is 1% of the total power. FIG. 3B demonstrates sensitivity curves at the critical coupling point but with biased detuning when the power of each sideband is 1% of the total power.

FIG. 3C also demonstrates sensitivity curves depending on coupling regime, but when the power of each sideband is 10% of the total power. FIG. 3D shows sensitivity curves of the critical coupling point with biased detuning when the power of each sideband is 10% of the total power. In FIG. 3, the sensitivities are normalized to unity of each figure. As expected, the 0 dB squeeze is substantially similar to what is expected in conventional PDH locking techniques.

In embodiments, the noise floor after demodulation increases if the cavity deviates from critical coupling, as shown in FIGS. 3A and 3C. With a higher-level squeezed vacuum state, the squeezed-light-enhanced PDH locking techniques disclosed herein perform much better than conventional PDH locking schemes (except where the critical coupling point and zero detuning conditions are both fulfilled). Because the critical coupling point with zero detuning is the only sweet spot in traditional PDH locking, it can be hard to reach and maintain locking in practice. In contrast, as shown in FIG. 3, embodiments disclosed herein overcome such disadvantages.

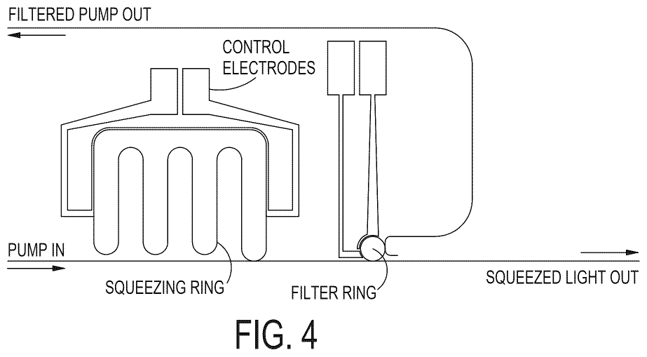

Embodiments herein may utilize an on-chip squeezed-light source. FIG. 4 shows a microscope image of such an on-chip squeezed light source in accordance with one or more embodiments. The on-chip squeezed-light source is based on a SiN microring resonator. The microring resonator is fabricated on a thick SiN wafer (e.g., 600 nm). The microring resonator may be engineered to operate in the anomalous dispersion regime so that the efficiency of four-wave mixing is boosted to support the efficient generation of the squeezed light. In the example of FIG. 4, the microring resonator may be pumped by a 1550-nm laser injected through an edge coupler onto the chip to generate nondegenerate squeezed light. The pump photons are filtered by a second microring resonator, and the remaining photons are collected by a fiber. In this example, the on-chip squeezing level was estimated to be ~3 dB based on measurement data; however, this value was affected by the available on-chip pump power and any coupling loss on the output. Embodiments using the microring resonator may achieve >13 dB of squeezing.

The squeezed-light enhanced PDH locking techniques described herein may suppress the shot noise in all non-ideal cases, which extends the reliability of PDH locking in inadequate conditions. In accordance with embodiments disclosed herein, if the optical field at a central frequency is squeezed, the overall performance may be boosted, and the advantage of using the squeezed light benefit the SNR even with conditions of critical coupling and zero detuning.

The method steps outlined in any of the embodiments described herein may not restricted to being performed in any particular order. Also, structures or systems mentioned in any of the method embodiments may utilize structures or systems mentioned in any of the device/system embodiments. Such structures or systems may be described in detail with respect to the device/system embodiments only but are applicable to any of the method embodiments.

Features in any of the embodiments described in this disclosure may be employed in combination with features in other embodiments described herein, such combinations are considered to be within the spirit and scope of the present invention.

Even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

While preferred embodiments have been described above, those skilled in the art who have reviewed the present disclosure will readily appreciate that other embodiments can be realized within the scope of the invention. Accordingly, the present invention should be construed as limited only by any appended claims.

1. A quantum-enhanced gyroscopic device comprising:
a mirror resonator; and
a light source that provides light to probe the mirror resonator, the light comprising quantum-enhanced light.

2. The device of claim 1, wherein the quantum-enhanced light comprises counter-propagating quantum squeezed light.

3. The device of claim 1, wherein the quantum-enhanced light comprises quantum entangled light.

4. The device of claim 3, further comprising an array of sensors, wherein the quantum-enhanced gyroscopic device is a gyroscope.

5. The device of claim 1, further comprising:
a beam splitter that splits the light into a first split portion and a second split portion;
wherein the mirror resonator is part of a Pound-Drever-Hall (PDH) device that locks the first split portion to a resonant frequency; and
wherein a frequency shift between the first split portion and the second split portion is used to control the light source.

6. The device of claim 5, wherein the mirror resonator comprises an optical ring cavity.

7. The device of claim 5, wherein the mirror resonator comprises an optical linear cavity.

8. The device of claim 1, wherein the light source comprises:
a laser;
a broadband squeezing source, wherein an output of the laser interacts with the broadband squeezing source to produce a higher frequency component and a lower frequency component with opposite relative phases.

9. The device of claim 1, wherein the light source is squeezed light.

10. A squeezed-light enhanced Pound-Drever-Hall (PDH) locking module, the module comprising:
a light source that provides quantum-enhanced light;
a beam splitter that splits the quantum-enhanced light into a first split portion and a second split portion;
a mirror resonator that locks the first split portion to a resonant frequency,
wherein a frequency shift between the first split portion and the second split portion is used to lock the module.

11. The module of claim 10, wherein the quantum-enhanced light comprises counter-propagating quantum squeezed light.

12. The module of claim 10, wherein the quantum-enhanced light comprises quantum entangled light.

13. The module of claim 10, wherein the mirror resonator comprises an optical ring cavity.

14. The module of claim 10, wherein the mirror resonator comprises an optical linear cavity.

15. The module of claim 10, wherein the light source comprises:
a laser;
a broadband squeezing source, wherein an output of the laser interacts with the broadband squeezing source to produce a higher frequency component and a lower frequency component with opposite relative phases.

16. The module of claim 10, wherein the light source is a device that produces squeezed light.

17. The module of claim 16, wherein the light source is an on-chip squeezed light source.

18. The module of claim 17, wherein the light source comprises a microring resonator disposed on a SiN wafer.
